(19) United States
(12) Patent Application Publication
(10) Pub. No.: US 2026/0132652 A1
(43) Pub. Date: May 14, 2026

(54) HANDLE RETURN ASSEMBLY AND HANDLE FOR A DOOR OR WINDOW

(71) Applicant: Uhlmann & Zacher GmbH, Waldbüttelbrunn (DE)

(72) Inventors: Karl-Heinz SCHMÜCK, Waldbüttelbrunn (DE); Günter UHLMANN, Höchberg (DE)

(21) Appl. No.: 19/444,998

(22) Filed: Jan. 9, 2026

Related U.S. Application Data
(63) Continuation of application No. PCT/EP2024/067700, filed on Jun. 24, 2024.

(30) Foreign Application Priority Data
Jul. 11, 2023 (EP) 23184648.6

(51) Int. Cl. E05B 3/06; E05B 1/00; E05B 15/00

(52) U.S. Cl. CPC E05B 3/065; E05B 1/003; E05B 15/0053

(57) ABSTRACT

A handle return assembly 1, comprising at least a support 60 with a rear abutment surface 63 configured for being aligned with a door leaf's front or rear side, an opening extending from the front surface 61 to the rear surface 62 allows to reliable reposition a door handle 10 into a neutral position one the door handle 10 has been releases if the rosette 1 further comprises at least a first bearing, at least a first repositioner 100 and at least a first biasing member 130. The first repositioner 100 has a first cam bearing surface 104 facing towards the axis and defining a first distance between the first cam bearing surface 104 and the axis 2 and the first bearing movably supports the first repositioner 100 relative to the support 60 to be movable between a first radially retracted position and a first radially extended position. The first distance is smaller if the first repositioner is in the first radially retracted position than it is if the first repositioner 100 is in the first extended position. Further, the first repositioner 100 is biased by the first biasing member 130 towards the first radially retracted position.

### BACKGROUND

### 1. Field of the Invention

The invention relates to a door handle rosette, a door handle and a door.

### 2. Description of the Related Art

In the USA ANSI-BHMA-156.2 compliant mortise locks are very popular. Such mortise locks are as well referred to as “Bored Latch Lock” and usually include a latch housing that is inserted with a first end in the door jamb facing narrow side of a door leaf. The opposite second end of the housing faces a door jamb's striking plate if the door is closed. The latch housing movably supports a latch bolt (latch for short) being spring loaded towards its extended position, i.e. towards the door jamb to engage into a recess of the door jamb's striking plate in case the door is closed. The latch housing may further support a dead bolt and/or a guard bolt. A pull rod extends out of the second end of the housing and is coupled with the latch and the optional dead bolt such that an axial movement of the pull rod in a direction that faces away from the housing retracts the latch bolt and the (optional) dead bolt. Example of these US-style mortise locks are shown in e.g. in U.S. Pat. No. 2,576,648 (without dead bolt) and U.S. Pat. No. 11,459,796 B2. The free end of the pull rod is coupled via a transmission to a door handle, usually in the shape of a door knob. The transmission and/or the door handle may comprise a locking system for releasably blocking rotation of the door knob.

European mortise locks are usually inserted as well in a mortise in a door jamb facing narrow side of a door leaf (see DIN 18251). The dimensions are significantly larger than those of US-style (i.e. ANSI-BHMA-156.2 compliant) mortise locks, but in turn European mortise locks usually provide the advantage of having two distinct interfaces for operating the lock: A first interface is a so-called nut, configured to receive a square shaft supporting at least one handle. A rotation of the shaft and hence nut enables to retract a latch of the mortise lock. The other interface is a recess for receiving a cylinder lock having a cam (cf. DIN 18252). Rotating the cam of the cylinder lock enables to extend or retract a dead bolt of the European mortise locks and/or the latch. The European style mortise locks are very similar to ANSI-BHMA-156.13 compliant mortise locks.

Document GB 2 359849 A discloses a spring cassette for a door handle mechanism.

Document EP 1 918 492 A2 relates to a fitting for the mounting of a handle on a door or a window.

Document DE 87 02 724 U1 relates to a door fitting with a handle.

Document DE 295 11 809 U1 relates to a reset mechanism for fittings of doors, windows or the like.

### SUMMARY OF THE INVENTION

Embodiments of the invention are based on the observation that the spring biasing the latch of related art US-style mortise locks towards the extended position as well rotates the door handle back from the open orientation into the closed orientation. For ‘knob style’ door handles this return mechanism mostly works flawless because the rotational symmetry of door knobs provides the advantage that the torque for rotating them back into the closed orientation is very low. However, these knob type door handles are for some persons (kids, older persons, disabled persons) difficult to operate. So called “lever style” door handles have advantages for these persons as the increased lever arm can be rotated with a reduced physical effort.

The biasing springs of existing US-style mortise locks, however, are typically not dimensioned to maintain a lever-style handle in the horizontal position as the corresponding preload would render it even more difficult to open the door if a knob is installed. Sagging lever-style handles are unavoidable, if the lock includes a clutch that decouples the handle from the latch in case the lock is ‘locked’. This observation has well been made with European-style mortise locks. As apparent and usual in the technical field of locks, the term “to lock” does not only cover blocking the handle to thereby prevent a retraction of the latch and/or the dead bolt, but as well (or in addition) to decouple the handle from the latch which results as well in the inability to retract the latch and/or the dead bolt.

Retrofitting knob equipped doors with lever style door handles is hence difficult—if not impossible. It was suggested to couple the handle portion of a lever style door handle via a spring to a rosette of the door handle (see U.S. Pat. No. 10,927,569) to compensate for the gravity induced toque on the lever. However, this solution limits the product design to comparatively thick shaft portions of the lever style door handle.

It is hence an object of the invention to provide a reliable and cheap to manufacture mechanism that returns a lever-style handle for a door or a window into a predefined orientation.

The handle return assembly may be integrated in a door lock and/or a rosette. Herein, we will assume, the that the handle return assembly may be included by a rosette or may be integrated in a rosette for a door or a window. However, it is emphasized that this is only a vivid example of an application of the invention. Generally, the term rosette could be replaced by “handle return assembly”.

The handle return assembly includes at least a support. The support may be configured to be mounted to a door leaf's front side and/or to a door leaf's rear side. Only for simplicity, herein it is not distinguished between the front and the rear face of a door.

The support hence has a rear surface and a front surface, wherein the rear surface may include an abutment surface. The rear abutment surface may be configured to abut a door leaf's front side. In other words, the rear abutment surface may be configured to being aligned with a door leaf's front or rear side. In another example a side surface of the support provides an abutment surface. All being required is that the support can be mounted torque proof to a door leaf, a door jamb and/or a window frame. Only for conceptual simplicity, we herein assume that the abutment surface is a rear abutment surface, but it is emphasized that the adjective “rear” of rear abutment surface can be cancelled.

An opening in the support may extend from the front surface to the rear surface. The opening may hence be considered a through hole. The opening may be configured to receive a door handle shaft, i.e., the shaft of a door handle as used to transmit a rotation of the door handle's handpiece (e.g. via a transmission) to a mortise lock. Hence, the opening defines an opening axis that extends through the opening and may be normal to the abutment surface (if it is provided by the rear surface). For illustrational purposes, one may consider the axis of the opening to be at least almost identical or at least essentially parallel (for example parallel with an error margin of ±15°) with the axis of a door handle shaft, once the door handle has been added.

Preferably, the handle return assembly further includes at least one of a first bearing, at least a first repositioner and at least a first biasing member.

The first repositioner may have a first cam bearing surface facing towards the opening axis (axis, for short). The first cam bearing surface thus defines a first distance between the first cam bearing surface and the axis.

The first bearing may movably support the first repositioner relative to the support between a first radially retracted position and a first radially extended position. In other words, relative to the support, the first repositioner may be movable from the first radially retracted position to the first radially extended position and back. In the first radially retracted position of the repositioner, the distance between the axis and the cam bearing surface may be smaller than in the first extended position.

At least a first biasing member biases (loads) the first repositioner towards the first radially retracted position. For example, an elastic deformation of the biasing member may result in a restoring force pushing and/or pulling the first repositioner towards the first retracted position, at least if the first repositioner has been moved towards the first radially extended position.

This handle return assembly allows to return a door handle to a predefined position or orientation (neutral state) by simply adding a door handle and/or a door handle shaft with a cam having a cam surface that abuts the cam bearing surface. The preloaded repositioner provides a restoring force on the cam once the handle is rotated out of its ‘neutral’ orientation into a deflected orientation, because the cam pushes the repositioner against the biasing member. The restoring force translates into a restoring torque on the door handle that rotates the door handle back into its neutral orientation and the handle return assembly back into its neutral state. By adjusting the azimuthal position of the cam, the azimuthal position (the orientation) of the door handle can be selected. Herein this neutral position is as well referred to as the predefined position or predefined orientation. Further, the azimuthal position of the cam allows to define the direction in which the restoring torque acts, which direction has to be adapted to the side (left or right) on which the door hinges are mounted.

Preferably, the handle return assembly further includes at least one of a second bearing, at least a second repositioner and at least a second biasing member. Similarly to the first repositioner, the second repositioner may include a second cam bearing surface facing towards the axis and defining a second distance between the second cam bearing surface and the axis. The second bearing may movably support the second repositioner relative to the support to be movable between a second radially retracted position and a second radially extended position, wherein the second distance is smaller if the second repositioner is in the second radially retracted position than it is if the second repositioner is in the second extended position. The description of the first repositioner may be read on the second repositioner as well. The second repositioner may be loaded by the same first biasing member towards the second retracted position. Alternatively or in addition there may be a second biasing member. The second repositioner allows to significantly increase the restoring torque and to reduce the amount of material needed for the support because the first and the second repositioners may be connected to each other by at least the first biasing member. There is no need to support the respective biasing member/s by the support, which reduces the required amount of material for the support.

In an example, the support may have a first abutment and the first repositioner may have a first block. The first block and the first abutment may face towards each other (i.e., their respective surfaces may be configured to bear a force). Preferably, the distance between the first abutment and the first block decreases with increasing first distance of the first cam bearing surface to the axis. The first biasing member may extend between the first abutment and the first block, thereby forcing/biasing the first repositioner towards the axis and hence towards the first radially retracted position of the first repositioner. Similarly, the support may have at least a second abutment and the second repositioner may have a second block. The second block and the second abutment may face towards each other (i.e., their respective surfaces may be configured to bear a force). Preferably, the distance between the second abutment and the second block reduces with increasing second distance of the second cam bearing surface to the axis. The second biasing member may extend between the second abutment and the second block, thereby forcing the second repositioner towards the axis towards the second radially retracted position. To make it more vivid, when moving the first and/or the second repositioner towards their respective radially extended position the respective biasing member is compressed because the distance between the first and/or second abutment and the first and/or second block, respectively, is reduced.

In an example, a first portion of the first and/or second biasing member engage/s into a recess or behind an edge of the first repositioner, and a second portion of the respective biasing member engages into a recess or an edge of the second repositioner. This allows to pull the two repositioners towards each other and hence to reduces strength requirement of the support and hence the material required to manufacture a sufficiently strong support (assuming the same material is used). Another technical advantage is that this measure allows to increase the restoring torque by increasing the spring rate without significantly increasing the volume of the handle return assembly. Experiments showed that the size constraints of typical rosettes and mortise locks limit an increase of the spring rate of compression springs, because an increase of the spring rate comes with an increase of the spring's wire diameter (for a given material and a given number of windings). An increase in the wire diameter, however, reduces the maximum free path of compression, because the spring cannot be further compressed if the windings abut each other. A tension-spring does not suffer this disadvantage, the spring rate can be increased by using a thicker wire.

In a preferred example, the first or/and second bearing/s is/are a linear bearing/s. In other words, at least one of the repositioners may be a slider being loaded by the corresponding biasing element(s) towards the axis. The linear bearing/s may be formed by the support, e.g. as a rail or a groove. This measure further allows to enhance the restoring torque, as the space to place additional biasing elements is increased.

The bearings can be plain bearings, being simple (cheap) and reliable for the present application. The bearing surfaces may be surfaces of the support and/or of the respective repositioner.

In a preferred example, the handle return assembly may further include a cam plate with at least a first cam and an outer ring surface. The cam plate may be rotatably supported relative to the first and/or second repositioner. The surface of the first or/and second cam bearing surface/s may abut the ring surface. Preferably, the cam surface is a part of the ring surface. Thus, a rotation of the cam plate pushes the repositioner/s towards their extended positions and thereby loads the biasing member. This load of the biasing member causes a restoring force by pushing the repositioner against the cam. An advantage of the cam plate is that it allows to simply couple the handle return assembly, e.g. as a door rosette, to standard shafts (e.g. standard square shafts) and hence to retrofit existing doors with sagging door handles with the handle return assembly by simply providing a coupling element in the cam plate that fits on the door handle's shaft. Further, by simply providing multiple cam plates, the handle return assembly can be adapted to almost any shaft of the door handle. In other words, the cam plate may include a first coupling element configured to receive a second coupling element of a door handle shaft. In another example, the cam plate may be unitary with or firmly mounted to a door handle shaft.

For example, the door handle shaft may have an input shaft and an output shaft. The input shaft and the output shaft may be connected by a clutch. The cam plate may be unitary with the input shaft and/or is (at least configured to be) coupled to the input shaft. As usual, the input shaft may be torque proof connected to the door handle's handpiece and the output shaft may be configured to be coupled (e.g. via a transmission) to a mortise lock. Thus, a rotation of the handpiece results in a rotation of the input shaft and operation of the mortise lock, if the clutch is closed. Because the cam plate is torque proof coupled to (or unitary with) the input shaft, the door handle returns automatically into the predefined position once released.

In a preferred example, the cam plate includes at least two first cams being azimuthally spaced from each other with an at least local minimum of the distance d(φ) of the ring surface to the axis as a function of the azimuth angle φ. This preferred example allows to mount the same handle return assembly to either side of a door (or to both sides), because regardless of the direction of rotation for rotating the handpiece, the handpiece obeys a restoring torque. Further, it is ensured that the handpiece does not rotate back beyond the predefined angle, because this would result in an increase of the potential energy stored in the biasing member(s).

Of course, the handle return assembly with the shaft may be completed to a door handle for example, a handpiece may be coupled to the input shaft and the cam plate may be torque proof connected or unitary with the input shaft.

As already apparent, the handle return assembly has a neutral state in which the at least one repositioner is in the radially retracted position. If the at least on repositioner is moved towards its radially extended position, the handle return assembly is in a so-called deflected state as in this state a door lever being optionally attached to the handle return assembly would be deflected.

The term “biasing members” shall be understood as a synonym for any elastic member configured to load the respective repositioner towards its retracted position. Example of biasing members are any kind of suited springs, e.g. screw springs or leaf springs. Extension springs are preferred as explained above.

Only to avoid potential misunderstandings, and as already apparent from the above, the terms block and abutment are used synonymous. The two terms have only been used to verbally distinguish two blocks with a gap in between. The first and/or second biasing element may be located in the gap and exert a force onto the block and the abutment.

Further, “according to at least claim x” shall be understood such that the corresponding claim optionally depends on any one of the previous claims as long as it depends at least indirectly on claim x, wherein x indicates one or more claims.

As usual in mechanical engineering the term “a coupling” references to a machine element that provides a usually permanent torque transmitting connection between two rotatable parts (usually shafts and/or lever arms). Two terms are coupled if they are connected by a coupling. The coupling may be integrated in the parts being coupled. A clutch provides a selective coupling between two shafts and shall be distinguished from the term coupling, herein.

The term repositioner can be understood as mechanical device with a cam bearing surface configured to (re)position a rotatable supported cam towards a predefined azimuthal position.

### BRIEF DESCRIPTION OF THE DRAWINGS

In the following, the invention will be described by way of example, without limitation of the general inventive concept, on examples of embodiment and with reference to the drawings.

FIG. 1 shows a perspective view of a door handle with a handle return assembly.

FIG. 2 shows a rear view of the handle return assembly and the door handle with the handle being in a neutral position.

FIG. 3 shows section A-A as indicated in FIG. 2.

FIG. 4 shows section B-B as indicated in FIG. 2.

FIG. 5 shows a rear view of the handle return assembly with repositioners in a deflected state.

FIG. 6 shows section A-A as indicated in FIG. 5.

FIG. 7 shows section B-B as indicated in FIG. 5.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention is to cover all modifications, equivalents and alternatives falling within the spirit and scope of the present invention as defined by the appended claims.

### DETAILED DESCRIPTION

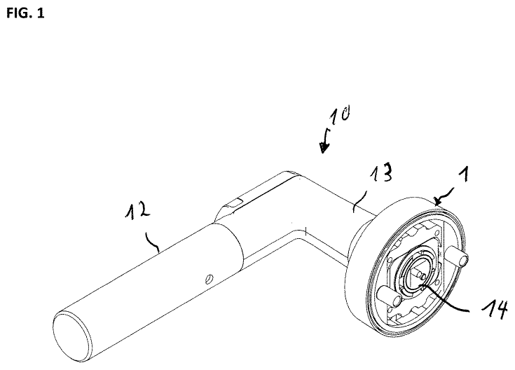

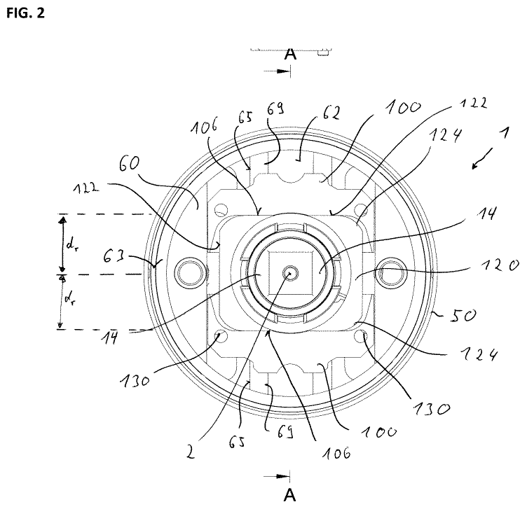

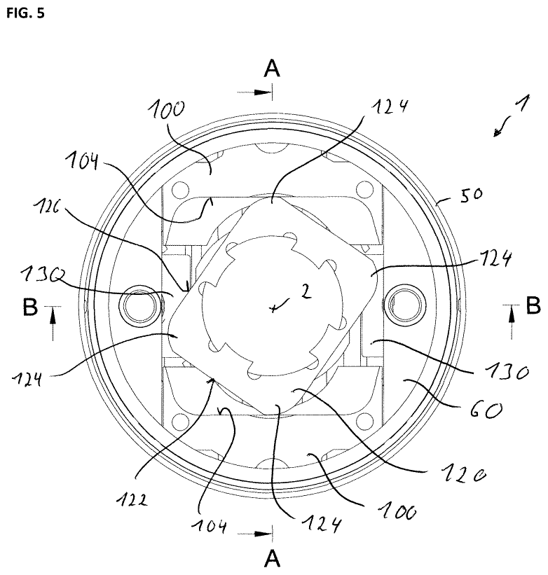

FIG. 1 shows a door handle 10 with a handle return assembly 1. As shown in the figure, the door handle 10 may be a lever-style door handle with a door lever 12, but any other shape may be used as well. The door lever 12 may be attached to a shaft section 13 of the door handle 10, i.e. pivoting the door lever 12 rotates the shaft section 13. The shaft section 13 may be coupled to and/or unitary with an input shaft 14. The input shaft 14 may be coupled via a clutch with a drive shaft and the drive shaft may be coupled via a transmission with the latch and/or a dead bolt of a mortise lock. If the optional clutch is closed, pivoting the door lever 12 rotates the input shaft 14, the output shaft and the causes via the transmission a retraction of the latch and/or the dead bolt. If the optional clutch is open, the door handle 10 and the mortise lock are decoupled, i.e. pivoting the door lever 12 (or another type of handle) does not cause a retraction of the latch and/or the dead bolt. FIGS. 2 to 4 show the handle return assembly of FIG. 1 in different views in the so-called neutral state. FIGS. 5 to 7 show the same handle return assembly, but some elements (e.g. the input shaft) have been omitted to show some otherwise hidden features. Further, FIGS. 5 to 7 show the handle return assembly's repositioners 100 in the so-called deflected state.

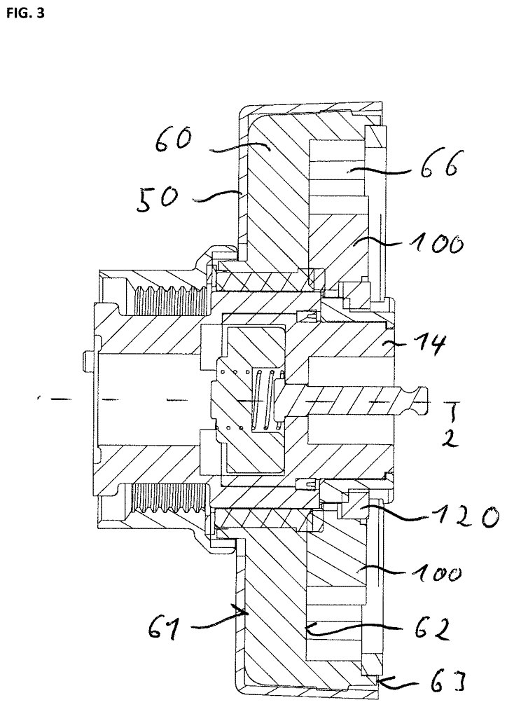

FIG. 2 shows a rear view of the handle return assembly 1. The handle return assembly 1 has a support 60 configured to be attached to a door leaf with its rear surface 62. The front surface 61 of the support 60 is show in FIG. 3 and may be covered by a handle return assembly cover 50. As shown in the example of FIG. 2, only a portion of the rear surface 62 may be configured to abut a door leaf and hence is a (rear) abutment surface 63, but this is not required.

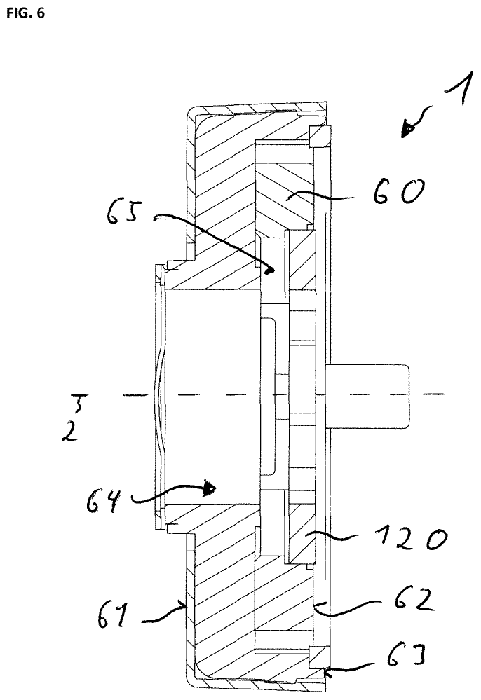

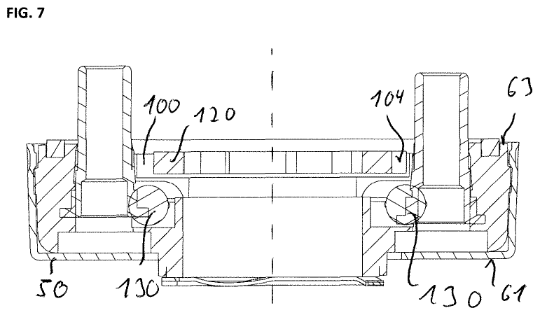

The support has an opening 64 extending from the front surface 61 to the rear surface 62 (see FIGS. 6 and 7). The opening 64 may be configured to receive a shaft of a door handle 10, e.g., the input shaft 14 (as shown in FIG. 1 to FIG. 4). The opening 64 thus defines an opening axis 2 that may be assumed to be the rotational axis 2 of the input shaft 14. As usual it may be assumed that the opening axis 2 (axis 2 for short) is normal to the rear abutment surface 63, i.e., when mounting the support 60 to a door leaf by attaching it with its rear abutment surface 63 to a front or rear side of the door leaf, the axis 2 is perpendicular (or in other words normal) to the door leaf. If the abutment surface is located at the side, of the support, the relative orientations change accordingly.

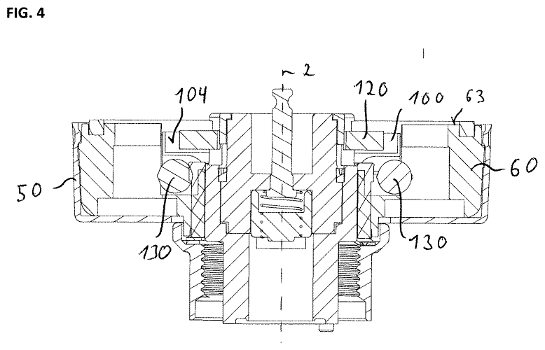

The handle return assembly 1 may further include at least one repositioner 100. In the example, two repositioners 100 are shown, herein referred to as first repositioner 100 and second repositioner 100. Higher numbers of repositioners 100 are as well possible. A bearing may movably support the two repositioners 100 relative to the support 60. In more detail, a first bearing 69 may be configured to enable a movement of the first repositioner 100, for example to be movable forth and back between a first radially retracted position and a first radially extended position. In the first radially retracted position of the repositioner 100, the distance dᵣ between the axis 2 and the cam bearing surface 104 may be smaller than in the first extended position (see FIG. 4). Similarly, a second bearing 69 may be configured to enable a movement of the second repositioner 100, for example to be movable forth and back between a second radially retracted position and a second radially extended position. In FIG. 2, the two repositioners 100 are depicted in their respective radially retracted positions and in FIG. 4 in their radially extended positions.

As already apparent, the bearings 69 movably supporting the first repositioner 100 may be referred to as fist bearing 69 and the bearing movably supporting the second repositioner 100 may be referred to as second bearing 69. In the present example, these bearings 69 are plain bearings each with a corresponding pair of bearing surfaces 65. These bearing surfaces 65 may be unitary with the support 60 or the corresponding repositioner 100, respectively. Other types of bearings 69 may be used as well (roller bearings, hydrostatic bearings, . . . ). The bearings 69 allow to move each of the repositioners 100, jointly or independently from each other, between the first or second radially retracted position to the first or second radially extended position.

As can be seen in FIGS. 2 to 7, the support 60 may have a recess 66 accommodating at least the repositioners 100. Each repositioner 100 may include a cam bearing surface 104, i.e. the first repositioner 100 may have a first cam bearing surface 104 and the second repositioner 100 may have a second cam bearing surface 104. Each of the cam bearing surfaces 104 has a distance dᵣ to the axis 2 and moving a repositioner 100 towards its radially extended position increases the respective distance. Accordingly, moving a repositioner 100 towards its radially retracted position decrease the distance dᵣ of the respective cam bearing surface 104 to the axis 2.

The first repositioner 100 may be biased by a first and/or a second biasing member 130 towards the first radially retracted position. Similarly, the second repositioner may be biased by the first biasing member 130 and/or the second biasing member 130 towards the second radially retracted position as shown. In the present example, the first and the second biasing members 130 are extension springs 130, but other biasing means can be used as well. Each of the two biasing members 130 has a first end and a second end. The first ends of the two biasing members 130 may be attached to the first repositioner 100 and the opposite second ends of the at least two biasing members may be attached to the second repositioner 100. In this context attached to shall be understood to imply that the attachment is configured to transmit the tensile forces exerted by the biasing members to the repositioners 100. Thus, a movement of the repositioners 100 towards their radially extended position loads the biasing members 130 and thereby biases the repositioners 100 towards the axis 2.

A cam plate 120 may be located in between of the cam bearing surfaces 104. As the name implies, the cam plate 120 has at least one cam 124 (four being shown in FIGS. 2 and 3, but this number is a preferred example). The cam plate 120 may be rotatable relative to the axis 2 of the support 60 and has an outer ring surface 122 that may include the surface of at least one cam 104 (e.g., of all cams 104, as depicted). In the depicted example, rotating the cam plate 120 in a first azimuthal direction causes two diagonally opposed cams 124 of the cam plate 120 to slide over the cam bearing surfaces 104 of the two repositioners 100, thereby pushing the repositioners 100 against the restoring force of the biasing members 130 towards their respective radially extended positions. The restoring force of the biasing members 130 is converted by the cams 124, which act as lever arms, into a restoring torque being opposite to the first azimuthal direction. Coupling a door handle 10 to the cam plate 120, hence, results in a restoring torque configured to rotate the door handle 10 back into its initial ‘neutral’ orientation.

Preferably, the cam plate 120 has four cams 124 (other numbers are possible as well). In the depicted example, these four cams 124 form a set of to first cams 124 and a set of two second cams 124. A first cam 124 of the two cams 124 of each set of cams 124 urges the corresponding repositioner 100 towards its radially extended position if the cam plate 120 is rotated in the first azimuthal direction and hence contributes to the generation of a restoring torque in the opposite (second) azimuthal direction that is configured to rotate the cam plate 120 back towards the initial (=neutral) azimuthal position. If the cam plate 120 is rotated in the second azimuthal direction, the second cams 104 of the two cams 124 of each set of cams 124 urges the corresponding repositioner 100 towards its radially extended position and hence contribute to the generation of a restoring toque in the first azimuthal direction. This allows to mount the handle return assembly 1 on either side of a door leaf, regardless of the direction of rotation. In either case, a door handle 10 being coupled to the cam plate 120 may be rotated back into the initial position. Of course, the handle return assembly may as well be mounted to both sides of the door leaf. Further, between the two cams 124 of each set of cams 124 may be a straight section 106 of the ring surface 122.

This straight section 106 provides a local minimum of the potential energy being stored in the biasing member(s) as a function of azimuthal deflection of the cam plate 120 and hence a well-defined initial azimuthal position of the cam plate 120. This initial azimuthal position is herein as well referred as neutral azimuthal position (see FIGS. 1 to 3). The straight surface is only an example that provides a single local minimum of the potential energy of the biasing member(s) between two cams 124 of the same set of cams 124. More generally, one has to consider the distance of the contact area between ring surface 122 and the cam bearing surface 104 to the axis 2 and configure the two contacting surfaces 104, 122 to have a single minimum of said distance between the two contacting surfaces 104, 122 and the axis 2.

Any other contour of the ring surface section between the two cams 124 that has a single (local) minimum of the distance of the contact area of the cam bearing surface 104 and the axis 2 provides as well a pre-defined neutral position of the cam plate 120 and hence of the door handle 10. For example, assuming to maintain the plain cam bearing surfaces 104 one would obtain as well such a minimum if the ring surface section between the cams 104 of a set is concave. Alternatively or in addition the contour of the cam bearing surface 104 can be convex. A convex contour of the cam bearing surface 104 provides an increase in the travel path of the repositioner 100 and hence an increase in the potential energy being stored in the biasing member, if the cam plate 120 is rotated out of the neutral position.

As can be seen in FIGS. 3 and 4, the shaft 14 of a door handle 10 may extend into or through a recess of the cam plate 120 and may be torque proof coupled to the cam plate 120. In the present example, the shaft 14 is an input shaft 14 of a clutch, but this is only a preferred feature.

It will be appreciated to those skilled in the art having the benefit of this disclosure that this invention is believed to provide a handle return assembly. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 handle return assembly (e.g. in the shape of a rosette)
2 axis
10 door handle (optional)
12 door lever (optional)
14 input shaft (optional)
50 handle return assembly cover(optional)
60 support
61 front surface (optional)
62 rear surface (optional)
63 (rear) abutment surface (optional)
64 opening (optional)
65 plain bearing surface (optional)
66 recess (optional)
69 bearing (optional)
100 repositioner (optional)
104 cam bearing surface (optional)
120 cam plate (optional)
122 ring surface (optional)
124 cam (optional)
126 straight section (optional)
130 optional biasing member, e.g. spring,

1.-12. (canceled)

13. A handle return assembly comprising at least a support, wherein the support comprises:
a front surface and a rear surface, wherein the support comprises an abutment surface and wherein the rear surface is configured for being aligned with a door leaf's front or rear side,
an opening extending from the front surface to the rear surface, wherein the opening defines an opening axis that extends through the opening and is normal to the rear abutment surface,
the support further comprises at least a first bearing, at least a first repositioner and at least a first biasing member,
the first repositioner has a first cam bearing surface facing towards the axis and defining a first distance between the first cam bearing surface and the axis,
the first bearing movably supports the first repositioner relative to the support to be movable between a first radially retracted position and a first radially extended position, wherein the first distance is smaller if the first repositioner is in the first radially retracted position than it is if the first repositioner is in the first extended position,
the support further comprises at least a second bearing, at least a second repositioner and at least a second biasing member,
the second repositioner has a second cam bearing surface facing towards the axis and defining a second distance between the second cam bearing surface and the axis,
the second bearing movably supports the second repositioner relative to the support to be movable between a second radially retracted position and a second radially extended position, wherein the second distance is smaller if the second repositioner is in the second radially retracted position than it is if the second repositioner is in the second extended position,
characterized in, that
the first repositioner is biased by the first biasing member and the second biasing member towards the first radially retracted position,
the second repositioner is biased by the first biasing member and the second biasing member towards the second radially retracted position,
wherein the first ends of the at least two biasing members are attached to the first repositioner and the opposite second ends of the at least two biasing members are attached to the second repositioner.

14. The handle return assembly according to claim 13, wherein:
a first portion of the first and/or second biasing member engages into a recess or behind an edge of the first repositioner, and
a second portion of the respective biasing member engages into a recess or an edge of the second repositioner,
the first and/or second biasing member is configured to load the first repositioner and the second repositioner towards each other.

15. The handle return assembly according to claim 13, wherein the first bearing or/and the second bearing is/are linear bearing(s).

16. The handle return assembly according to claim 13, wherein the first bearing and/or the second bearing is/are plain bearing(s).

17. The handle return assembly according to claim 13, wherein the handle return assembly further comprises a cam plate with a ring surface, wherein the cam plate is rotatably supported relative to the first repositioner and/or the second repositioner, wherein the first bearing surface or/and the second cam bearing surface abut(s) the ring surface.

18. The handle return assembly according to claim 17, wherein the cam plate is unitary and/or coupled with a door handle shaft and/or comprises a first coupling element configured to receive a second coupling element of the door handle shaft.

19. The handle return assembly according to claim 18, wherein the door handle shaft has an input shaft and an output shaft that are connected by a clutch, and wherein the cam plate is unitary with the input shaft and/or is coupled to the input shaft.

20. The handle return assembly according to claim 17, wherein the cam plate comprises at least two first cams that are azimuthally spaced from each other with an at least local minimum of a distance d from the ring surface being a function of an azimuth angle φ.

21. A door handle comprising the handle return assembly according to claim 17.

22. The door handle according to claim 21, wherein the door handle shaft has an input shaft and an output shaft that are connected by a clutch, wherein the cam plate is unitary with the input shaft and/or is coupled to the input shaft, and wherein a handpiece is coupled to the input shaft and a mortise lock is coupled to the output shaft.

23. The door handle according to claim 22, wherein the cam plate is torque proof connected with the input shaft or is unitary with the input shaft.

24. A door with a door leaf and with the handle return assembly according to claim 13.

25. A door with a door and the door handle according to claim 21.
